(19) United States
(12) Patent Application Publication
(10) Pub. No.: US 2026/0323504 A1
(43) Pub. Date: Oct. 15, 2026

(54) REPORTING USER EQUIPMENT ASSISTANCE INFORMATION TO FACILITATE RADIO ACCESS NETWORK ENERGY SAVINGS

(71) Applicant: TELEFONAKTIEBOLAGET LM ERICSSON (PUBL), Stockholm (SE)

(72) Inventors: Sladana Josilo, SOLNA (SE); Lian Araujo, SOLNA (SE); Nianshan Shi, JÄRFÄLLA (SE); Sina Maleki, Malmö (SE)

(21) Appl. No.: 19/101,163

(22) PCT Filed: Aug. 4, 2023
(86) PCT No.: PCT/IB2023/057925

§ 371 Date: Feb. 4, 2025

Related U.S. Application Data
(60) Provisional application No. 63/395,352, filed on Aug. 5, 2022.

(51) Int. Cl. H04W 52/02

(52) U.S. Cl. CPC H04W 52/0206; H04W 52/0216

(57) ABSTRACT

Embodiments include methods performed by a user equipment (UE) for facilitating radio access network (RAN) energy-saving operations. Such methods include obtaining a configuration for reporting of UE assistance information for RAN energy-saving operations. Such methods include determining that one or more types or parameters of UE assistance information are available and selectively sending, to a RAN node, a report of UE assistance information in accordance with the configuration. The report includes the one or more types or parameters determined to be available. Other embodiments include complementary methods performed by a RAN node, as well as UEs and RAN nodes configured to perform such methods.

### TECHNICAL FIELD

The present disclosure relates generally to radio access networks (RANs) and more specifically to techniques for managing and/or reducing energy consumed by a RAN based on assistance information reported by user equipment (UEs) served by the RAN.

### BACKGROUND

Currently the fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. 5G was initially standardized by 3GPP in Rel-15 and continues to evolve through later releases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in EPC 198 via respective S1-C interfaces. Similarly, gNBs can connect to one or more Serving Gateways (SGWs) in EPC via respective NG-U interfaces.

In addition, the gNBs can be connected to each other via one or more Xn interfaces, such as Xn interface (140) between gNBs (100, 150). Each of the gNBs can serve a geographic coverage area including one or more cells. The radio technology used by gNBs to communicate with user equipment (UE) in the cells is often referred to as “New Radio” (NR). In general, each of the gNBs can support frequency division duplexing (FDD), time division duplexing (TDD), or a combination thereof in the NR radio interface to the UEs.

In addition, each of the gNBs can use various directional beams to provide the coverage in the respective cells. In general, a DL “beam” is a coverage area of a network-transmitted reference signal (RS) that may be measured or monitored by a UE. One example DL RS is synchronization signal/PBCCH blocks (SSBs), which are transmitted in each cell and used by UEs to perform cell search and acquisition of time/frequency synchronization. For example, up to N SSBs (beams) are transmitted sequentially in a cell, each covering a different area of the cell.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each of the CUs and DUs can include various circuitry needed to perform their respective functions, such as processing circuitry, communication interface circuitry, and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

FIG. 2 shows a logical architecture for a gNB arranged in the split CU/DU architecture, such as gNB 100 in FIG. 1. This logical architecture separates the CU into control plane (CP) and user plane (UP) functionality, called CU-C and CU-U respectively. Furthermore, each of the NG, Xn, and F1 interfaces is split into a CP interface (e.g., NG-C) and a UP interface (e.g., NG-U). Note that the terms “Central Entity” and “Distributed Entity” in FIG. 2 refer to physical network nodes.

Energy consumption is a considerable challenge for 5G systems, with a major contributor being the energy consumption of the radio unit of the gNBs. Network energy consumption for NR is intended to be less than for fourth generation Long-Term Evolution (LTE) networks, for example, due to the elimination of cell RS (CRS) and the relatively long 20-ms default SSB periodicity. However, current NR network implementations may consume more energy than LTE networks due to increased carrier bandwidths, reduced transmit time intervals (TTIs), and use of massive numbers of antennas. This network energy consumption manifests itself even when NR cells and beams are lightly loaded or serve no traffic or users.

One goal of 3GPP Release 18 (Rel-18) is improving and/or reducing network energy consumption, particularly with respect to cells and beams that are lightly loaded or serve no traffic or users. Some example techniques include reducing DL transmit power in, or turning off completely, a cell or a beam serving no traffic.

Even so, it is desirable to base RAN energy-saving operations on information gathered from UEs. One way a UE can provide such “assistance information” to its serving gNB is by a radio resource control (RRC) message called UEAssistanceInformation. This message may include several different types of information, such as a preferred UE discontinuous reception (DRX) setting, an indication that the UE is overheated, etc. The different information elements (IEs) of this message are independent, such that the serving gNB can configure the UE to send the specific information needed by the gNB.

### SUMMARY

Different UE information relevant to RAN energy-saving operations may have very different characteristics. For example, some information may change frequently and thus requires a quick reaction by the gNB, while other information may change infrequently and thus can be handled more leisurely by the gNB (e.g., with a delay). However, the current RRC UEAssistanceInformation message is unsuitable for fast-changing UE information relevant to RAN energy-saving operations.

It is also unclear how to trigger the UE to report information relevant to RAN energy-saving operations. For example, the current RRC UEAssistanceInformation message is only sent upon request by the serving gNB, which means that a UE may be unable to report an urgent change in information relevant to RAN energy-saving operations for a significant period Furthermore, how to trigger and report UE information relevant to RAN energy-saving operations is particularly important for the split node architecture shown in FIGS. 1-2, since some protocol layers (e.g., RRC/PDCP) resides in the gNB-CU and other protocol layers (e.g., RLC, MAC, PHY) reside in the gNB-DU.

An object of embodiments of the present disclosure is to facilitate predictable and timely UE reporting of information relevant to RAN energy-saving operations, as well as RAN node (e.g., gNB) use of such information, such as by providing solutions to the exemplary problems summarized above and described in more detail below.

Some embodiments include methods (e.g., procedures) performed by a UE (e.g., wireless device, MTC device, NB-IOT device, etc.) for facilitating RAN energy-saving operations.

These exemplary methods include obtaining a configuration for reporting of UE assistance information for RAN energy-saving operations. These exemplary methods also include determining that one or more types or parameters of UE assistance information are available. These exemplary methods also include selectively sending, to a RAN node, a report of UE assistance information in accordance with the configuration. The report includes the one or more types or parameters determined to be available.

In some embodiments, the configuration for reporting of UE assistance information identifies at least one type or parameter of UE assistance information to be reported by the UE. The one or more types or parameters determined to be available are among the at least one type or parameter to be reported.

In some embodiments, the configuration for reporting of UE assistance information identifies one or more conditions or events that trigger reporting of UE assistance information. In such case, determining that one or more types or parameters of UE assistance information are available includes detecting at least one event or condition identified by the configuration. In some of these embodiments, the one or more conditions or events that trigger reporting of UE assistance information include one or more of the following:
one or more thresholds related to UL data available at the UE;
a traffic type of UL data available at the UE;
one or more thresholds related to DL signals received or measured by the UE;
a value for a timer whose expiration triggers reporting of UE assistance information;
one or more UE mobility procedures;
a request or command from the RAN node; and
one or more conditions related to UE energy consumption.

In some variants of these embodiments, these exemplary methods also include, upon sending a most recent report of UE assistance information to the RAN node, initiating a timer with the value identified by the configuration. The timer is running when it is determined that the one or more types or parameters of UE assistance information are available. Also, selectively sending the report of UE assistance information includes delaying sending the report until expiration of the timer.

In some further variants, the most recent report includes a first type or parameter of UE assistance information. In such case, selectively sending the report of UE assistance information includes, when the value of the timer is infinity, refraining from sending the report unless the one or more available types or parameters of the UE assistance information are different than the first type or parameter.

In some variants of these embodiments, the one or more conditions related to UE energy consumption include one or more of the following:
UE overheating; and
a change in UE preference for one or more of the following, to reduce UE energy consumption: carrier aggregation, dual connectivity, maximum bandwidth, discontinuous reception (DRX), maximum number of transmission layers, RRC state, reference signal periodicity, and scheduling offset.

In some variants of these embodiments, one or more of the following applies:
the one or more UE mobility procedures include one or more of the following, whose completion triggers reporting of UE assistance information: handover, reconfiguration, connection setup, connection re-establishment, and connection resume; and
the one or more UE mobility procedures include connection suspend, whose onset triggers reporting of UE assistance information.

In some embodiments, the UE is configured to operate in dual connectivity (DC) with a master cell group (MCG) and a secondary cell group (SCG). In such case, the configuration for reporting of UE assistance information includes a first set of conditions or events that trigger reporting of UE assistance information associated with the MCG and a second set of conditions or events that trigger reporting of UE assistance information associated with the SCG.

In some embodiments, the configuration for reporting of UE assistance information includes an indication of a RAN node sleep pattern, which includes one or more first time/frequency resources that are available for uplink (UL) access by UEs and one or more second time/frequency resources that are unavailable for UL access by UEs due to the RAN node being in a lower-energy state. In such embodiments, selectively sending the report of UE assistance information includes refraining from sending the report until a next one of the first time/frequency resources, which is used to send the report.

In some embodiments, these exemplary methods also include receiving from the RAN node a request for UE assistance information for RAN energy-saving operations. The report is sent responsive to the request and includes the one or more types or parameters of UE assistance information determined to be available when the UE received the request.

In some embodiments, these exemplary methods also include receiving from the RAN node a command to enable or disable reporting of UE assistance information for RAN energy-saving operations. In such case, selectively sending the report of UE assistance information includes the following operations:
sending the report of UE assistance information responsive to a command to enable reporting; and
refraining from sending a report of UE assistance information responsive to a command to disable reporting.

In some embodiments, selectively sending the report of UE assistance information includes the following operations:
sending the report of UE assistance information via a higher protocol layer when one or more first conditions are met; and
sending the report of UE assistance information via a lower protocol layer when one or more second conditions are met.

In some of these embodiments, the one or more first conditions include one or more of the following:
the configuration specifies the higher protocol layer for the one or more available types or parameters of UE assistance information; and
the one or more available types or parameters of UE assistance information include relatively static information;

In some of these embodiments, the one or more second conditions include one or more of the following
the configuration specifies the lower protocol layer for the one or more available types or parameters of UE assistance information;
the one or more available types or parameters of UE assistance information include relatively dynamic information; and
the UE receives a request for UE assistance information via the lower protocol layer.

In some of these embodiments, the higher protocol layer is RRC layer and the lower protocol layer is MAC layer or PHY layer.

In some embodiments, these exemplary methods also include subsequently releasing or discarding the configuration in response to re-establishing or resuming the UE's connection to the RAN. In some embodiments, the report of UE assistance information includes one of the following for each type or parameter included in the report: a value for the type or parameter, an index corresponding to a value for the type or parameter, or absence of the type or parameter that was included in a previous report. Note that the absence indicates a change in a UE preference or condition.

In some embodiments, obtaining the configuration for reporting of UE assistance information includes one of the following operations: receiving the configuration from the RAN node, or retrieving the configuration from UE memory.

Other embodiments include methods (e.g., procedures) performed by a RAN node (e.g., base station, eNB, gNB, etc.) for managing RAN node energy consumption. These exemplary methods are generally complementary to the embodiments of UE methods summarized above.

These exemplary methods include sending to the UE a configuration for reporting of UE assistance information for RAN energy-saving operations. These exemplary methods also include selectively receiving or monitoring for a report of UE assistance information from the UE in accordance with the configuration. These exemplary methods also include, in response to receiving the report, performing one or more operations to manage RAN node energy consumption based on the received UE assistance information.

In different embodiments and variants thereof, the configuration for reporting of UE assistance information can include any of the same content as the corresponding configuration summarized above in relation to embodiments of UE methods.

In some variants, these exemplary methods also include receiving a most recent report of UE assistance information from the UE at a first time. In such variants, selectively receiving or monitoring for a report of UE assistance information includes delaying monitoring for a next report of UE assistance information until the value for the timer after the first time. In some further variants, the most recent report includes a first type or parameter of UE assistance information and selectively receiving or monitoring for a report of UE assistance information also includes, where when the value of the timer is infinity, receiving the report only when the one or more available types or parameters of the UE assistance information are different than the first type or parameter.

In some embodiments, selectively receiving or monitoring for a report of UE assistance information includes the following operations:
monitoring for a report of UE assistance information in first time/frequency resources that are available for UL access, and
refraining from monitoring for a report of UE assistance information in second time/frequency resources that are not available for UL access.

In some embodiments, these exemplary methods also include sending to the UE a request for UE assistance information for RAN energy-saving operations. The report is received responsive to the request and includes one or more types or parameters of UE assistance information the UE determined to be available when the UE received the request.

In some embodiments, these exemplary methods also include sending to the UE a command to enable or disable reporting of UE assistance information for RAN energy-saving operations. In such case, selectively receiving or monitoring for a report of UE assistance information includes the following operations:
monitoring for a report of UE assistance information responsive to sending a command to enable reporting; and
refraining from monitoring for a report of UE assistance information responsive to sending a command to disable reporting.

In some embodiments, selectively receiving or monitoring for a report of UE assistance information includes the following operations:
receiving the report of UE assistance information via a higher protocol layer when one or more first conditions are met; and
receiving the report of UE assistance information via a lower protocol layer when one or more second conditions are met.

In various embodiments, the one or more first conditions and the one or more second conditions can include any of the corresponding conditions summarized above in relation to UE method embodiments. In some of these embodiments, the higher protocol layer is RRC layer and the lower protocol layer is MAC layer or PHY layer.

In some embodiments, the report of UE assistance information includes one of the following for each type or parameter included in the report: a value for the type or parameter, an index corresponding to a value for the type or parameter, or absence of the type or parameter that was included in a previous report. Note that the absence indicates a change in a UE preference or condition.

In some embodiments, these exemplary methods also include generating a second report based on the UE assistance information in the report received from the UE and sending the second report to a second RAN node. In some of these embodiments, the second report is sent to the second RAN node during handover of the UE to a cell served by the second RAN node.

In some embodiments, the one or more operations to manage RAN node energy consumption based on the received UE assistance information include one or more of the following:
deactivating one or more secondary cells for the UE;
reducing a periodicity of reference signals transmitted by the RAN node;
reconfiguring a connection with the UE;
updating a sleep pattern used by the RAN node; and
realigning transmissions to and/or from a group of UEs, including the UE, to increase the proportion of time the RAN node sleeps or operates in a lower-energy state.

Other embodiments include user UEs (e.g., wireless devices, MTC devices, NB-IOT devices, or components thereof, such as a modem) and RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments described herein can enable a RAN node to trigger the reporting of UE assistance information from the UE in various ways that are appropriate to the type of UE assistance information being reported. As a specific example, the RAN node can cause the UE to report slowly changing UE assistance information in a different ways than the UE reports UE assistance information that changes more quickly. As another specific example, the RAN node can set various events or conditions that cause the UE to report UE assistance information, thereby ensuring that the RAN node receives needed or desired UE assistance information in a timely manner. Based on timely receipt of appropriate UE assistance information, the RAN node can take various actions to manage and/or reduce its own energy consumption. At a high level, embodiments can improve energy consumption of a RAN based on UE assistance information, without placing significant burden on UEs to report such information.

These and other objects, features, benefits, and advantages of embodiments of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G/NR network architecture.

FIG. 3 shows an exemplary configuration of NR user plane (UP) and control plane (CP) protocol stacks.

FIG. 4 shows a high-level view of dual connectivity (DC) in combination with carrier aggregation (CA).

FIGS. 5A-D show an example ASN.1 data structure for an RRC UEAssistanceInformation message.

FIG. 6 shows a flow diagram of an exemplary method (e.g., procedure) for a UE (e.g., wireless device), according to various embodiments of the present disclosure.

FIGS. 7A-B show a flow diagram of an exemplary method (e.g., procedure) for a RAN node (e.g., base station, eNB, gNB, ng-eNB, etc.), according to various embodiments of the present disclosure.

FIG. 8 shows a communication system according to various embodiments of the present disclosure.

FIG. 9 shows a UE according to various embodiments of the present disclosure.

FIG. 10 shows a network node according to various embodiments of the present disclosure.

FIG. 11 shows host computing system according to various embodiments of the present disclosure.

FIG. 12 is a block diagram of a virtualization environment in which functions implemented by some embodiments of the present disclosure may be virtualized.

FIG. 13 illustrates communication between a host computing system, a network node, and a UE via multiple connections, at least one of which is wireless, according to various embodiments of the present disclosure.

### DETAILED DESCRIPTION

Embodiments summarized above will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or similar terminology is sometimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

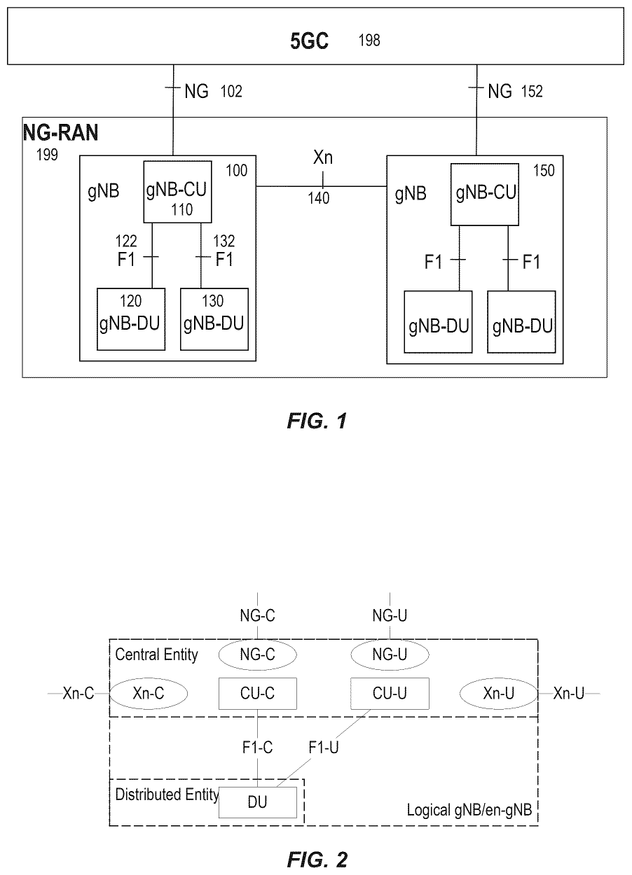

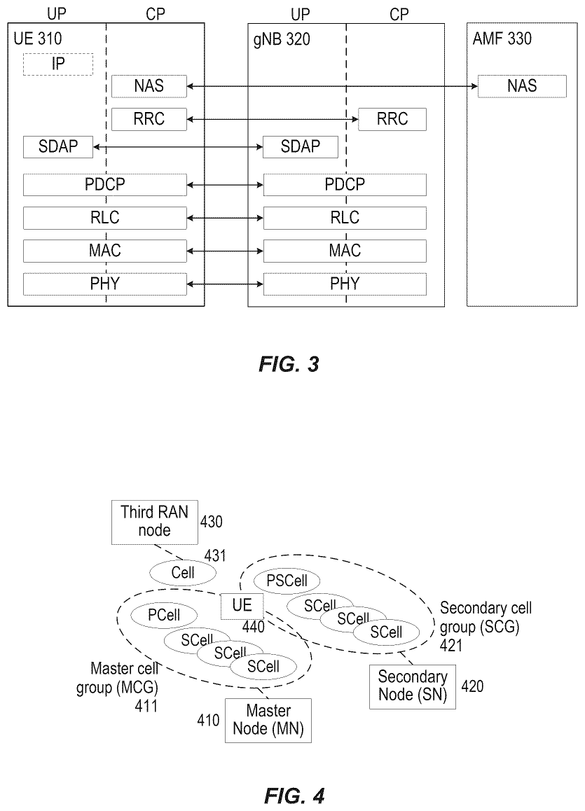

FIG. 3 shows an exemplary configuration of NR user plane (UP) and control plane (CP) protocol stacks between a UE (310), a gNB (320), and an AMF (330), such as those shown in FIGS. 1-2. Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB.

An NR UE in RRC_IDLE state is not known to the gNB serving the cell where the UE is camping. The UE must perform a random-access (RA) procedure to move from RRC_IDLE to RRC_CONNECTED state, where the cell serving the UE is known and an RRC context is established for the UE in the serving gNB, such that the UE and gNB can communicate. As part of (or in conjunction with) the RA procedure, the UE also transmits an RRCSetupRequest message to the serving gNB. NR RRC also includes an RRC_INACTIVE state in which a UE is known (e.g., via UE context) by the serving gNB. RRC_INACTIVE has some properties similar to a “suspended” condition used in LTE.

LTE Rel-10 supports bandwidths larger than 20 MHz. To remain compatible with legacy UEs from earlier releases (e.g., LTE Rel-8), a wideband LTE Rel-10 carrier (e.g., >20 MHZ) should appear as a plurality of carriers (“component carriers” or CCs), each preferably having the same structure as an LTE Rel-8 carrier. The Rel-10 UE can received the multiple CCs based on Carrier Aggregation (CA). The CCs can also be considered “cells”, such that a UE in CA has one primary cell (PCell) and one or more secondary cells (SCells).

LTE Rel-12 introduced dual connectivity (DC) whereby a UE can be connected to two network nodes simultaneously, thereby improving connection robustness and/or capacity. In LTE DC, these two network nodes are referred to as master eNB (MeNB) and secondary eNB (SeNB), or more generally as master node (MN) and secondary node (SN). A UE is configured with a Master Cell Group (MCG) associated with the MN and a Secondary Cell Group (SCG) associated with the SN. Each cell group includes a PCell and may include one or more SCells.

Several DC (or more generally, multi-connectivity) scenarios are considered for NR. These include NR-DC that is similar to LTE-DC mentioned above, except that both the MN and SN (referred to as “gNBs”) employ the NR interface to communicate with the UE. In addition, NR supports various multi-RAT DC (MR-DC) scenarios in which a UE can be configured to utilize resources from one node providing E-UTRA/LTE access and another node providing NR access. One node acts as the MN (e.g., providing MCG) and the other as the SN (e.g., providing SCG), with the MN and SN being connected via a network interface and at least the MN being connected to a core network (e.g., EPC or 5GC).

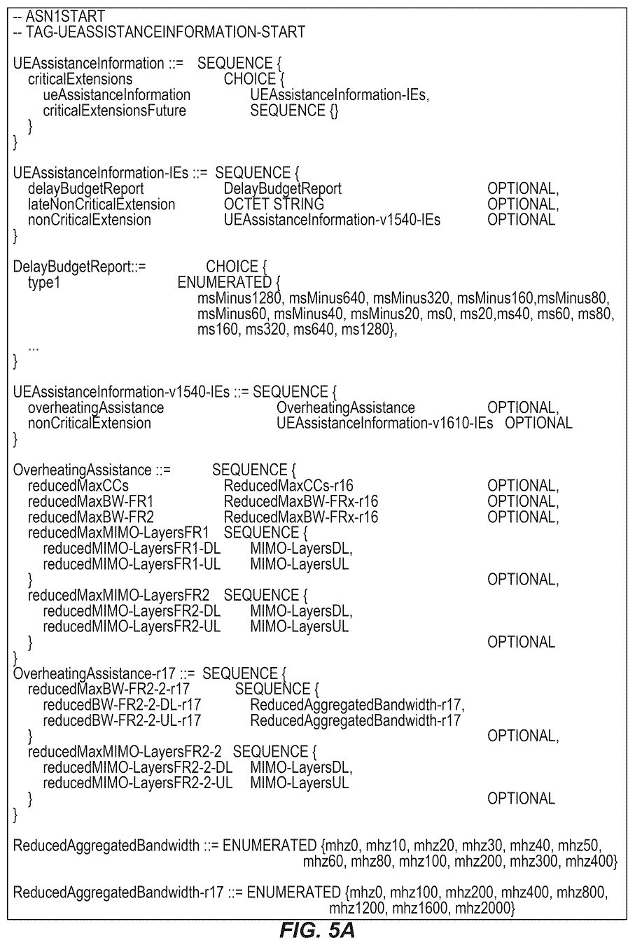

FIG. 4 shows a high-level illustration of a UE (440) arranged in DC with CA. In this illustration, each of the MN (410) and the SN (420) can be either an eNB or a gNB, in accordance with the various DC scenarios mentioned above. The MN provides the UE's MCG (411) consisting of a PCell and three SCells arranged in CA, while the SN provides the UE's SCG (421) consisting of a PSCell and three SCells arranged in CA. FIG. 4 also shows a third RAN node (430), which provides a cell (431) that is proximate to the cells of the MCG and/or the cells of the SCG. For example, the UE may communicate with the third RAN node via the cell (431) in case of failure in the MCG (or PCell), failure in the SCG (or PSCell), or in mobility procedures in which the third RAN node is a target node for the UE. In some cases, the cell (431) may be part of a cell group (not shown) that the third RAN node can provide to UEs. The MN, the SN, and the third RAN node can be connected via appropriate interfaces.

As briefly mentioned above, a UE can provide “assistance information” to its serving gNB is a radio resource control (RRC) message called UEAssistanceInformation. This message may include several different types of information, such as a preferred UE discontinuous reception (DRX) setting, an indication that the UE is overheated, etc. However, the gNB is not required to follow any recommendation or information provided by the UE, but may choose different settings (or refrain from making any changes) based on its own considerations regarding network resources, etc.

The different information elements (IEs) of the UEAssistanceInformation message are independent, such that the serving gNB can configure the UE to send the specific information needed by the gNB. For some types of information, the gNB can configure the UE to send separate information for the UE's MCG and the UE's SCG. The limit on how frequently the UE could send UEAssistanceInformation is usually determined by the prohibit timer set by the network for each requested field or IE.

According to 3GPP TS 38.331(v 17.1.0 ) section 5.7.4.1, the UE can inform the network of any of the following information via a UEAssistanceInformation message:
delay budget report carrying desired increment/decrement in the connected mode DRX cycle length;
overheating assistance information, ;
in-device coexistence (IDC) assistance information;
preference on DRX parameters for power saving;
preference on the maximum aggregated bandwidth for power saving;
preference on the maximum number of secondary component carriers for power saving, ;
preference on the maximum number of multi-input multi-output (MIMO) layers for power saving;
preference on the minimum scheduling offset for cross-slot scheduling for power saving;
preference on the RRC state;
configured grant assistance information for NR sidelink communication;
preference in being provisioned with reference time information;
preference for FR2 UL gap;
preference to transition out of RRC_CONNECTED state for MUSIM operation;
preference on the multi-subscriber identity module (MUSIM) gaps;
relaxation state for radio link management (RLM) measurements;
relaxation state for beam failure detection (BFD) measurements;
availability of data and/or signalling mapped to radio bearers which are not configured for small data transfer (SDT);
preference for the SCG to be deactivated;
indicate that the UE has uplink data to transmit for a data radio bearer (DRB) for which there is no MCG RLC bearer while the SCG is deactivated;
change of fulfilment status for radio resource management (RRM) measurement relaxation criterion; and
service link (specified in 3GPP TS 38.300) propagation delay difference between serving cell and neighbour cell(s).

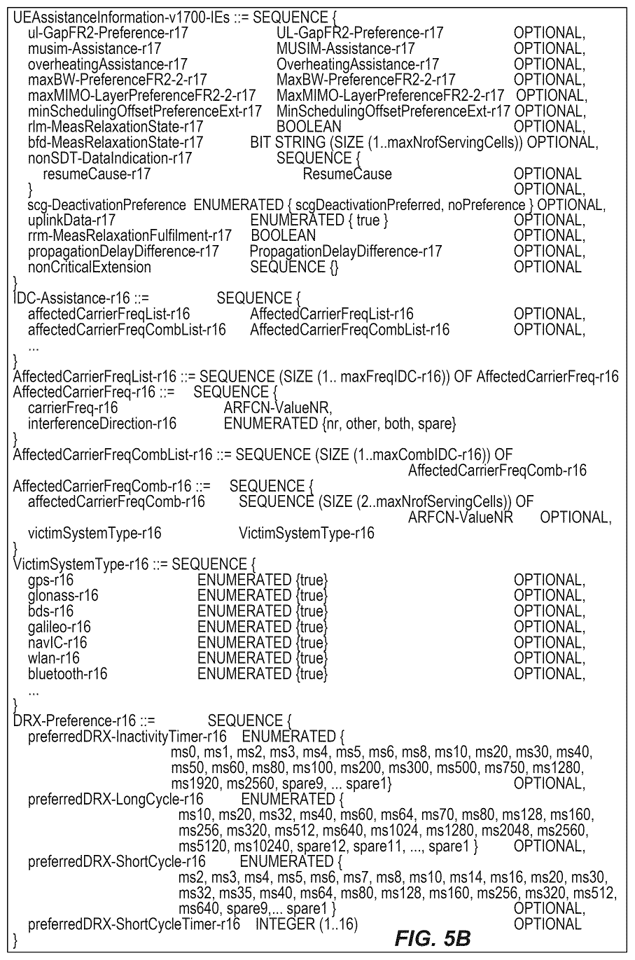

FIGS. 5A-D show an exemplary ASN.1 data structure for an RRC UEAssistanceInformation message, with the various message fields defined in 3GPP TS 38.331(v 17.1.0 ) section 6.2.2.

As mentioned above, energy consumption is a considerable challenge for 5G systems, with a major contributor being the energy consumption of the gNB radio units. One goal of 3 GPP Rel-18 is improving and/or reducing RAN energy consumption, particularly with respect to cells and beams that are lightly loaded or serve no traffic or users. Some example techniques include reducing DL transmit power in, or turning off completely, a cell or a beam serving no traffic.

Even so, it is desirable to base RAN energy-saving operations on relevant information gathered from UEs. For various reasons, however, the existing RRC UEAssistanceInformation message is inadequate for this purpose. For example, different UE information relevant to RAN energy-saving operations may have very different characteristics. Some information may change frequently and thus require a quick reaction by the UE's serving RAN node (e.g., gNB), while other information may change infrequently and thus can be handled more leisurely (e.g., with a delay). However, the current RRC UEAssistanceInformation message is not suitable for fast-changing UE information relevant to RAN energy-saving operations.

It is also unclear how to trigger the UE to report information relevant to RAN energy-saving operations. For example, the current RRC UEAssistanceInformation message is only sent upon request by the serving RAN node, which means that a UE may be unable to report an urgent change in information relevant to RAN energy-saving operations for a significant period. Furthermore, how to trigger and report UE information relevant to RAN energy-saving operations is particularly important for the split node architecture shown in FIGS. 1-2, since some protocol layers (e.g., RRC/PDCP) resides in the gNB-CU and other protocol layers (e.g., RLC, MAC, PHY) reside in the gNB-DU.

Embodiments of the present disclosure provide novel, flexible, and efficient signaling and procedures to facilitate a RAN node's management of its own energy consumption. Embodiments include techniques for a UE to selectively report UE assistance information for RAN node energy-saving operations, with the reporting being in accordance with a configuration provided by a RAN node and/or stored in UE memory. Other embodiments include techniques for a RAN node to selectively receive or monitor for reports of UE assistance information from a UE, which can be in accordance with the configuration provided by a RAN node. Upon receiving such a report, the RAN node can perform operations to manage RAN node energy consumption based on the received UE assistance information.

Embodiments can provide various benefits and/or advantages. For example, embodiments can enable a RAN node to trigger the reporting of UE assistance information from the UE in various ways that are appropriate to the type of UE assistance information being reported. As a specific example, the RAN node can cause the UE to report slowly changing UE assistance information in a different ways than the UE reports UE assistance information that changes more quickly. As another specific example, the RAN node can set various events or conditions that cause the UE to report UE assistance information, thereby ensuring that the RAN node receives needed or desired UE assistance information in a timely manner. Based on timely receipt of appropriate UE assistance information, the RAN node can take various actions to manage and/or reduce its own energy consumption. At a high level, embodiments can improve energy consumption of a RAN based on UE assistance information, without placing significant burden on UEs to report such information.

The terms “UE assistance information” and “UE report” are used interchangeably, both referring to UE information relevant to RAN energy-saving operations that is reported to the serving RAN node by the UE, e.g., via RRC (e.g., UEAssistanceInformation message), MAC control element (CE) or data unit, PHY UL control information (UCI), etc. For example, UE assistance information can include, but is not limited to, any of parameters represented in an RRC UEAssistanceInformation message, such as described above and specified in 3GPP TS 38.331(v 17.1.0 ).

In the following description, the term “RAN node sleep pattern” (or “sleep pattern”) refers to an operational pattern in which a subset of a RAN node's time/frequency resources are available for UE UL access while other of the RAN node's time/frequency resources are not available for UE UL access due to the RAN node possibly (but not necessarily) being asleep or otherwise in a lower-energy state with less functionality. The UE may not be aware of whether the RAN node is asleep or otherwise in a lower-energy state during those other time/frequency resources. Rather, the UE is only aware (e.g., based on a provided RAN node sleep pattern configuration) that it is allowed to contact the RAN node only during/using the subset of time/frequency resources.

In some embodiments, a UE can send UE assistance information for RAN energy-saving operations to its serving RAN node based on and/or responsive to a variety of different factors or conditions. For example, the serving RAN node may send a MAC CE including a command to allow (or enable) the UE to send, or to prohibit (or disable) the UE from sending, such UE assistance information. As another example, the serving RAN node may send a MAC CE including a request for the UE to send such UE assistance information.

In some variants, when the UE receives a RAN node command that allows sending UE assistance information, the UE may delay sending such UE assistance information until it becomes available at the UE or the UE determines a need to assist the RAN node with information for network energy savings. In other variants, when the UE receives a RAN node command that requests UE assistance information, the UE may send any available information responsive to the request, e.g., without delay for additional availability.

In some embodiments, thresholds may define when the UE should report assistance information relevant to network energy saving techniques. For certain types of assistance information, the UE may be configured with one or more thresholds that need to be fulfilled as a trigger for sending such information to the serving RAN node. For example, the UE may be configured with thresholds related to UL data transmissions (e.g., buffer status, data volume, packet size, etc.). For example, when the serving RAN node is asleep or otherwise in a state with lower energy consumption (e.g., according to a configured RAN node sleep pattern), the UE cannot send UL data to the RAN node. This causes the UE's UL data buffer to exceed a configured threshold, based on which the UE sends UE assistance information to the serving RAN node (e.g., during the next time/frequency resources available for UE UL access).

As another example, the UE may be configured with one or more received signal thresholds such as for reference signal received power (RSRP), reference signal received quality (RSRQ), and signal-to-interference-and-noise ratio (SINR). If the serving RAN node enters a lower-energy state in which it transmits at a lower power level, the UE's received SINR may drop below a configured threshold. than the configured threshold, causing the UE to send UE assistance information to the serving RAN node.

As another example, the UE may be configured with multiple thresholds that define multiple conditions for reporting UE assistance information. For example, the UE may be configured with a first threshold for UL data volume such that the UE's UL data volume exceeding the first threshold causes the UE to send UE assistance information to the serving RAN node. The UE may also be configured with a second threshold for UL data volume such that the UE's UL data volume being below the second threshold causes the UE to send UE assistance information to the serving RAN node. Alternately, the UE's UL data volume being above the second threshold but below the first threshold causes the UE to send UE assistance information to the serving RAN node.

In some embodiments, a timer may be used to prohibit frequent reports sent by the UE. For example, a timer can be initiated upon sending UE assistance information, and the UE can send other (i.e., next) UE assistance information only after expiration of the timer. For example, the timer period can have any value from a few seconds to infinity, where infinity indicates “one-shot” reporting of UE assistance information (i.e., of specific information). In some variants, each item of UE assistance information can be associated with a different timer period.

In some embodiments, after the UE sends a first UE report, it can only send a second UE report that different information (i.e., different parameters or changed values) than the first report. For example, the UE can only send a second UE report when the UE's traffic type has changed.

In some embodiments, the UE can only send UE assistance information that relates to (or is triggered by) specific condition(s) or cause(s), e.g., low battery, traffic level, traffic type. In different variants, this restriction may apply to a first (or initial) UE report and/or to second (or subsequent) UE report, such as in the example discussed above.

In some embodiments, the network may configure the UE to use any of the conditions discussed herein. In some embodiments, the UE may send (or refrain from sending) a UE report based on an event, condition, or information (e.g., UE UL traffic type, volume, or latency requirements) known by the UE but not by the serving RAN node. In other embodiments, the serving RAN node may request (or prohibit) a UE report based on an event, condition, or information known by the serving RAN node but not by the UE. As an example, the serving RAN node is preparing to update energy-saving technique being used (e.g., RAN node sleep pattern) and it wants to receive UE assistance information as an input for the intended update. In some variants, the serving RAN node may request (or prohibit) a UE report individually for each UE individually or collectively for a group of UEs (e.g., at the same time).

In some embodiments, the UE may send UE assistance information to its serving RAN node in response to a mobility procedure performed by the UE, such as handover or other reconfiguration procedures, connection setup, connection re-establishment, connection resume, or connection suspend. For example, immediately after handover (reconfiguration with sync) to a target cell, the UE sends UE assistance information to the RAN node serving the target cell. In some variants, the UE report may be intended for the RAN node serving the source cell for the handover, which causes the receiving target RAN node to send the UE report to the intended source RAN node.

In some embodiments, during handover of a UE, the source RAN node may forward the most recent UE assistance information to the target RAN node. In some embodiments, during handover preparation phase, the target RAN node may determine a configuration for UE assistance information and send it to the source RAN node, which sends the configuration to the UE during handover execution phase (e.g., in an RRCReconfiguration message).

In some embodiments, when a UE has been provided with a configuration based on which it reports UE assistance information for RAN energy-saving operations, the UE releases (or discards) this configuration upon performing a connection-related procedure, such as connection (e.g., RRC) re-establishment, connection (e.g., RRC) resume, etc.

The UE can be provided with the configuration for reporting of UE assistance information for RAN energy-saving operations in various ways. For example, the UE can receive the configuration from the serving RAN node. As another example, the UE can be pre-configured with the configuration, e.g., in UE memory. In such case, the configuration may be specified by a 3GPP standard or other relevant document.

In some embodiments, when a previous UE assistance information message includes a field pertaining to a UE condition or preference that can affect RAN energy-saving operations, absence of the same field in a subsequent UE assistance information indicates that the UE condition or preference no longer exists. As an example, if the UE has sent a UE assistance information message to with an indication of UE preference for sparse SSBs, the transmission of a new UE assistance information message where this indication of UE preference is absent corresponds to no longer having a preference for sparse SSBs.

In some embodiments, the conditions for triggering the UE report associated with the MCG and SCG can be different. Depending on the assistance information type, the UE can be configured to provide the assistance information for either all or only a subset of configured cells of the MCG or SCG, respectively.

In some embodiments, the frequency of sending UE assistance information may depend on the particular type of information being sent. For example, relatively static information (e.g., UE type, battery specification, location of stationary UE, etc.) may be sent only once, e.g., upon the UE establishing a connection with the serving RAN node. On the other hand, more dynamic information (e.g., UL data volume, UL buffer status, traffic type, coverage, location of non-stationary UE) may be sent more often, either periodically or on an as-needed (e.g., event triggered) basis.

Depending on how fast the assistance information from the UE changes, the UE can be configured to send reports in different ways. For example, relatively static information (e.g., UE type, battery specification, location of stationary UE, etc.) may be sent to the serving RAN node via higher-layer protocol, e.g., via RRC to the gNB-CU. On the other hand, more dynamic information (e.g., UL data volume, UL buffer status, traffic type, coverage, location of non-stationary UE) may be more relevant to lower layers and brief sleep configurations in the serving RAN node. As such, the more dynamic information may be sent to the serving RAN node via lower-layer protocol, e.g., via MAC CE/PDU or UCI to the gNB-DU. As an example, the UE may be configured to transmit UE assistance information by an aperiodic PHY triggering mechanism (e.g., DCI), based on which the UE sends the relevant information via UCI (i.e., on PUCCH or other control channel) or MAC CE/PDU (i.e., on PUSCH or other shared channel).

In some embodiments, for certain types or parameters of UE assistance information (e.g., preferred SSB configurations, delay tolerance, data rate traffic type, and time criticality), the UE can choose among predefined values/ranges with associated indices. In such case, the UE can send an index associated with the preferred range/value (e.g., index of preferred SSB periodicity) instead of specifying the preferred range/value itself. These embodiments facilitate smaller UE reports as well as easier synchronization among the UEs needed for achieving longer RAN node sleep periods.

Depending on the type of UE assistance information (e.g., how fast the certain assistance information changes), the serving RAN node can configure the UE to send the UE assistance information via RRC, MAC, or UCI, such as discussed above. Depending on the type of UE assistance information, the serving RAN node can configure different triggers (e.g., threshold or other event) that cause the UE to send the UE assistance information. Depending on the type of the assistance information, the serving RAN node can configure the UE to send the UE assistance information in a specific format (e.g., value or index to a predefined value/range).

In some embodiments, the serving RAN node can configure the UE to send UE assistance information for RAN energy-saving operations only during a time interval specified by the network. For example, based on its sleep pattern, the serving RAN node can configure the UE to send such UE assistance information only during the intervals when the node is not asleep or at a specific time in advance of an update to the serving RAN node's energy-saving techniques.

In some embodiments, upon receiving UE assistance information for RAN energy-saving operations from a UE, the serving RAN node may generate further assistance information to be sent to another RAN node. As an example, during UE handover, the UE's source RAN node may forward to the target RAN node any received UE assistance information along with further assistance information generated by the source RAN node, both of which may be relevant to RAN energy-saving operations used by the target RAN node.

In some embodiments, upon receiving UE assistance information for RAN energy-saving operations from a UE, the serving RAN node may activate (or add) or deactivate (or release) one or more of the UE's SCells, or otherwise reconfigure the UE. In some embodiments, a RAN node may reconfigure a group of UEs such that transmissions to/from the group are aligned in a way that increases the proportion of time the RAN node sleeps or operates in a lower-energy state.

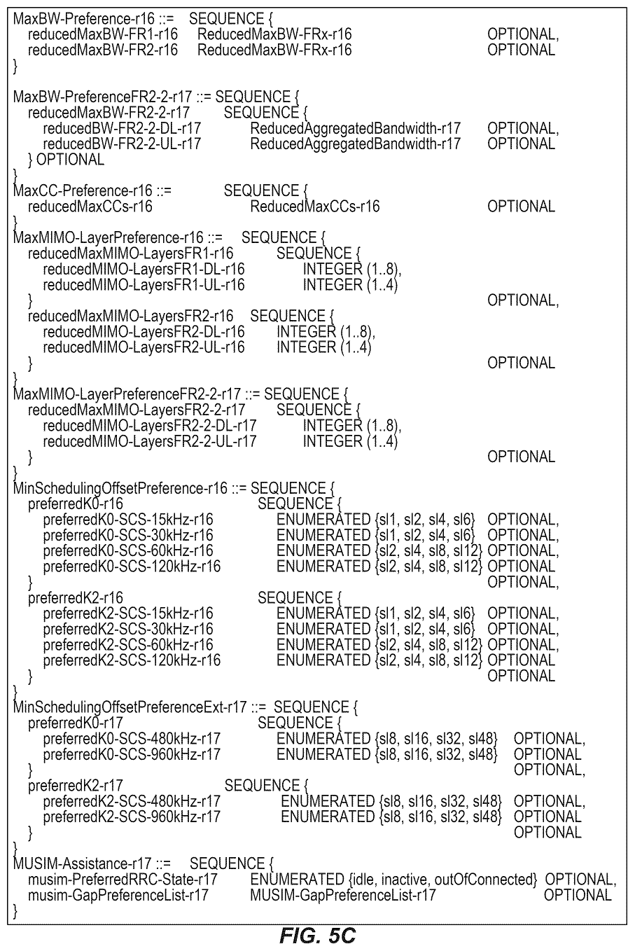

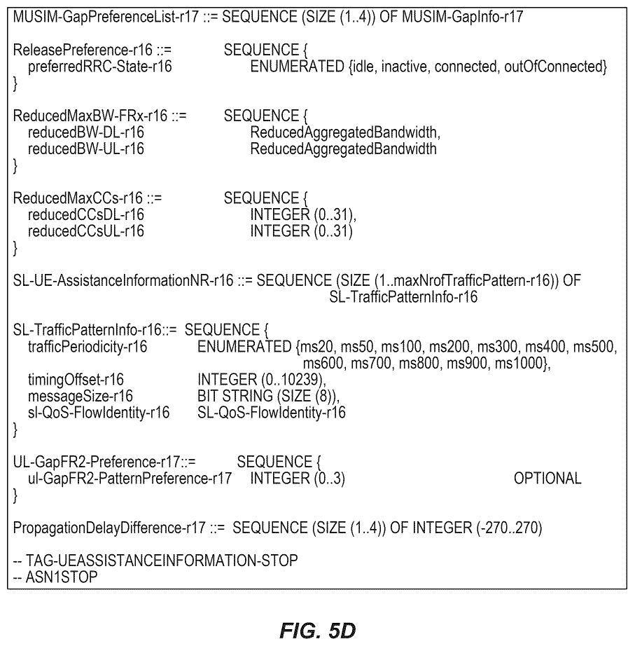

The embodiments described above can be further illustrated with reference to FIGS. 6-7, which show exemplary methods (e.g., procedures) for a UE and a RAN node, respectively. Put differently, various features of the operations described below correspond to various embodiments described above. Furthermore, the exemplary methods shown in FIGS. 6-7 can be used cooperatively to provide various benefits, advantages, and/or solutions to problems, including those described herein. Although FIGS. 6-7 show specific blocks in particular orders, the operations of the exemplary methods can be performed in different orders than shown and can be combined and/or divided into blocks with different functionality than shown. Optional blocks or operations are indicated by dashed lines.

In particular, FIG. 6 shows a flow diagram of an exemplary method (e.g., procedure) performed by a UE for facilitating RAN energy-saving operations, according to various embodiments of the present disclosure. The exemplary method shown in FIG. 6 can be performed by a UE (e.g., wireless device, MTC device, NB-IOT device, modem, etc. or component thereof) such as described elsewhere herein.

The exemplary method includes the operations of block 610, where the UE can obtain a configuration for reporting of UE assistance information for RAN energy-saving operations. The exemplary method can also include the operations of block 640, where the UE can determine that one or more types or parameters of UE assistance information are available. The exemplary method can also include the operations of block 650, where the UE can selectively send, to a RAN node, a report of UE assistance information in accordance with the configuration. The report includes the one or more types or parameters determined to be available.

In some embodiments, the configuration for reporting of UE assistance information identifies at least one type or parameter of UE assistance information to be reported by the UE. The one or more types or parameters determined to be available in block 640 are among the at least one type or parameter to be reported.

In some embodiments, the configuration for reporting of UE assistance information identifies one or more conditions or events that trigger reporting of UE assistance information. In such case, determining that one or more types or parameters of UE assistance information are available in block 640 includes the operations of sub-block 641, where the UE can detect at least one event or condition identified by the configuration. In some of these embodiments, the one or more conditions or events that trigger reporting of UE assistance information include one or more of the following:
one or more thresholds related to UL data available at the UE;
a traffic type of UL data available at the UE;
one or more thresholds related to DL signals received or measured by the UE;
a value for a timer whose expiration triggers reporting of UE assistance information;
one or more UE mobility procedures;
a request or command from the RAN node; and
one or more conditions related to UE energy consumption.

In some variants of these embodiments, the exemplary method can also include the operations of blocks 630-635, wherein upon sending a most recent report of UE assistance information to the RAN node, the UE can initiate a timer with the value identified by the configuration. The timer is running when it is determined in block 640 that the one or more types or parameters of UE assistance information are available. Also, selectively sending the report of UE assistance information in block 640 includes the operations of sub-block 641, where the UE can delay sending the report until expiration of the timer.

In some further variants, the most recent report includes a first type or parameter of UE assistance information. In such case, selectively sending the report of UE assistance information in block 640 includes the operations of sub-block 642, where when the value of the timer is infinity, the UE can refrain from sending the report unless the one or more available types or parameters of the UE assistance information are different than the first type or parameter.

In some variants of these embodiments, the one or more conditions related to UE energy consumption include one or more of the following:
UE overheating; and
a change in UE preference for one or more of the following, to reduce UE energy consumption: carrier aggregation, dual connectivity, maximum bandwidth, discontinuous reception (DRX), maximum number of transmission layers, RRC state, reference signal periodicity, and scheduling offset.

In some variants of these embodiments, one or more of the following applies:
the one or more UE mobility procedures include one or more of the following, whose completion triggers reporting of UE assistance information: handover, reconfiguration, connection setup, connection re-establishment, and connection resume; and
the one or more UE mobility procedures include connection suspend, whose onset triggers reporting of UE assistance information.

In some embodiments, the UE is configured to operate in dual connectivity (DC) with a master cell group (MCG) and a secondary cell group (SCG). In such case, the configuration for reporting of UE assistance information includes a first set of conditions or events that trigger reporting of UE assistance information associated with the MCG and a second set of conditions or events that trigger reporting of UE assistance information associated with the SCG.

In some embodiments, the configuration for reporting of UE assistance information includes an indication of a RAN node sleep pattern, which includes one or more first time/frequency resources that are available for uplink (UL) access by UEs and one or more second time/frequency resources that are unavailable for UL access by UEs due to the RAN node being in a lower-energy state. In such embodiments, selectively sending the report of UE assistance information in block 650 includes the operations of sub-block 653, where the UE can refrain from sending the report until a next one of the first time/frequency resources, which is used to send the report.

In some embodiments, the exemplary method can also include the operations of block 625, where the UE can receive from the RAN node a request for UE assistance information for RAN energy-saving operations. The report is sent in block 650 responsive to the request and includes the one or more types or parameters of UE assistance information determined to be available when the UE received the request.

In some embodiments, the exemplary method can also include the operations of block 620, where the UE can receive from the RAN node a command to enable or disable reporting of UE assistance information for RAN energy-saving operations. In such case, selectively sending the report of UE assistance information in block 650 includes the following operations, labelled with corresponding sub-block numbers:
(654) sending the report of UE assistance information responsive to a command to enable reporting; and
(655) refraining from sending a report of UE assistance information responsive to a command to disable reporting.

In some embodiments, selectively sending the report of UE assistance information in block includes the following operations, labelled with corresponding sub-block numbers:
(656) sending the report of UE assistance information via a higher protocol layer when one or more first conditions are met; and
(657) sending the report of UE assistance information via a lower protocol layer when one or more second conditions are met.

In some of these embodiments, the one or more first conditions include one or more of the following:
the configuration specifies the higher protocol layer for the one or more available types or parameters of UE assistance information; and
the one or more available types or parameters of UE assistance information include relatively static information;

In some of these embodiments, the one or more second conditions include one or more of the following
the configuration specifies the lower protocol layer for the one or more available types or parameters of UE assistance information;
the one or more available types or parameters of UE assistance information include relatively dynamic information; and
the UE receives a request for UE assistance information via the lower protocol layer.

In some of these embodiments, the higher protocol layer is RRC layer and the lower protocol layer is MAC layer or PHY layer.

In some embodiments, the exemplary method can also include the operations of block 660, where the UE can subsequently release or discard the configuration in response to re-establishing or resuming the UE's connection to the RAN.

In some embodiments, the report of UE assistance information includes one of the following for each type or parameter included in the report: a value for the type or parameter, an index corresponding to a value for the type or parameter, or absence of the type or parameter that was included in a previous report. Note that the absence indicates a change in a UE preference or condition.

In some embodiments, obtaining the configuration for reporting of UE assistance information in block 610 includes one of the following operations, labelled with corresponding sub-block numbers:
(611) receiving the configuration from the RAN node, or
(612) retrieving the configuration from UE memory.

In addition, FIG. 7 shows a flow diagram of an exemplary method (e.g., procedure) performed by a RAN node for managing RAN node energy consumption, according to various embodiments of the present disclosure. The exemplary method shown in FIG. 7 can be performed by a RAN node (e.g., eNB, gNB, ng-eNB, etc., or component thereof) such as described elsewhere herein.

The exemplary method includes the operations of block 710, where the RAN node can send to the UE a configuration for reporting of UE assistance information for RAN energy-saving operations. The exemplary method also includes the operations of block 750, where the RAN node can selectively receive or monitor for a report of UE assistance information from the UE in accordance with the configuration. The exemplary method also includes the operations of block 760, wherein in response to receiving the report, the RAN node can perform one or more operations to manage RAN node energy consumption based on the received UE assistance information.

In some of these embodiments, the configuration for reporting of UE assistance information identifies at least one type or parameter of UE assistance information to be reported by the UE. The report (i.e., when received) includes one or more of the at least one type or parameter to be reported.

In some of these embodiments, the configuration for reporting of UE assistance information identifies one or more conditions or events that trigger reporting of UE assistance information. In some variants of these embodiments, the one or more conditions or events that trigger reporting of UE assistance information include one or more of the following:
one or more thresholds related to UL data available at the UE;
a traffic type of UL data available at the UE;
one or more thresholds related to DL signals received or measured by the UE;
a value for a timer whose expiration triggers reporting of UE assistance information;
one or more UE mobility procedures;
a request or command from the RAN node; and
one or more conditions related to UE energy consumption.

In some further variants, the exemplary method also includes the operations of block 740, where the RAN node can receive a most recent report of UE assistance information from the UE at a first time. In such case, selectively receiving or monitoring for a report of UE assistance information in block 750 includes the operations of sub-block 751, where the RAN node delays monitoring for a next report of UE assistance information until the value for the timer after the first time.

In some further variants, the most recent report includes a first type or parameter of UE assistance information. In such variants, selectively receiving or monitoring for a report of UE assistance information in block 750 also includes the operations of sub-block 752, where when the value of the timer is infinity, the RAN node can receive the report only when the one or more available types or parameters of the UE assistance information are different than the first type or parameter.

In some further variants, the one or more conditions related to UE energy consumption include one or more of the following:
UE overheating; and
a change in UE preference for one or more of the following, to reduce UE energy consumption: carrier aggregation, dual connectivity, maximum bandwidth, DRX, maximum number of transmission layers, RRC state, reference signal periodicity, and scheduling offset.

In some further variants, the one or more UE mobility procedures include one or more of the following, whose completion triggers reporting of UE assistance information: handover, reconfiguration, connection setup, connection re-establishment, and connection resume. In other further variants, the one or more UE mobility procedures include connection suspend, whose onset triggers reporting of UE assistance information.

In some embodiments, the UE is configured to operate in DC with an MCG and an SCG. The configuration for reporting of UE assistance information includes a first set of conditions or events that trigger reporting of UE assistance information associated with the MCG and a second set of conditions or events that trigger reporting of UE assistance information associated with the SCG.

In some embodiments, the configuration for reporting of UE assistance information includes an indication of a RAN node sleep pattern, which includes one or more first time/frequency resources that are available for uplink (UL) access by UEs and one or more second time/frequency resources that are unavailable for UL access by UEs due to the RAN node being in a lower-energy state. In such case, selectively receiving or monitoring for a report of UE assistance information in block 750 includes the following operations, labelled with corresponding sub-block numbers:
(753) monitoring for a report of UE assistance information in the first time/frequency resources that are available for UL access, and
(754) refraining from monitoring for a report of UE assistance information in the second time/frequency resources that are not available for UL access.

In some embodiments, the exemplary method also includes the operations of block 730, where the RAN node can send to the UE a request for UE assistance information for RAN energy-saving operations. The report is received in block 750 responsive to the request and includes one or more types or parameters of UE assistance information the UE determined to be available when the UE received the request.

In some embodiments, the exemplary method also includes the operations of block 720, where the RAN node can send to the UE a command to enable or disable reporting of UE assistance information for RAN energy-saving operations. In such case, selectively receiving or monitoring for a report of UE assistance information in block 750 includes the following operations, labelled with corresponding sub-block numbers:
(755) monitoring for a report of UE assistance information responsive to sending a command to enable reporting; and
(756) refraining from monitoring for a report of UE assistance information responsive to sending a command to disable reporting.

In some embodiments, selectively receiving or monitoring for a report of UE assistance information in block 750 includes the following operations, labelled with corresponding sub-block numbers:
(757) receiving the report of UE assistance information via a higher protocol layer when one or more first conditions are met; and
(758) receiving the report of UE assistance information via a lower protocol layer when one or more second conditions are met.

In some of these embodiments, the one or more first conditions include one or more of the following:
the configuration specifies the higher protocol layer for one or more types or parameters of UE assistance information included in the report; and
the one or more types or parameters of UE assistance information included in the report comprise relatively static information.

In some of these embodiments, the one or more second conditions include one or more of the following
the configuration specifies the lower protocol layer for the one or more types or parameters of UE assistance information included in the report;
the one or more types or parameters of UE assistance information included in the report comprise relatively dynamic information; and
the RAN node previously sent to the UE, via the lower protocol layer, a request for UE assistance information for RAN energy-saving operations.

In some of these embodiments, the higher protocol layer is RRC layer and the lower protocol layer is MAC layer or PHY layer.

In some embodiments, the report of UE assistance information includes one of the following for each type or parameter included in the report: a value for the type or parameter, an index corresponding to a value for the type or parameter, or absence of the type or parameter that was included in a previous report. Note that the absence indicates a change in a UE preference or condition.

In some embodiments, the exemplary method can also include the operations of blocks 770-780, where the RAN node can generate a second report based on the UE assistance information in the report received from the UE and send the second report to a second RAN node. In some of these embodiments, the second report is sent to the second RAN node during handover of the UE to a cell served by the second RAN node.

In some embodiments, performing one or more operations to manage RAN node energy consumption based on the received UE assistance information in block 760 includes one or more of the following operations, labelled with corresponding sub-block numbers:
(761) deactivating one or more secondary cells for the UE;
(762) reducing a periodicity of reference signals transmitted by the RAN node;
(763) reconfiguring a connection with the UE;
(764) updating a sleep pattern used by the RAN node; and
(765) realigning transmissions to and/or from a group of UEs, including the UE, to increase the proportion of time the RAN node sleeps or operates in a lower-energy state.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

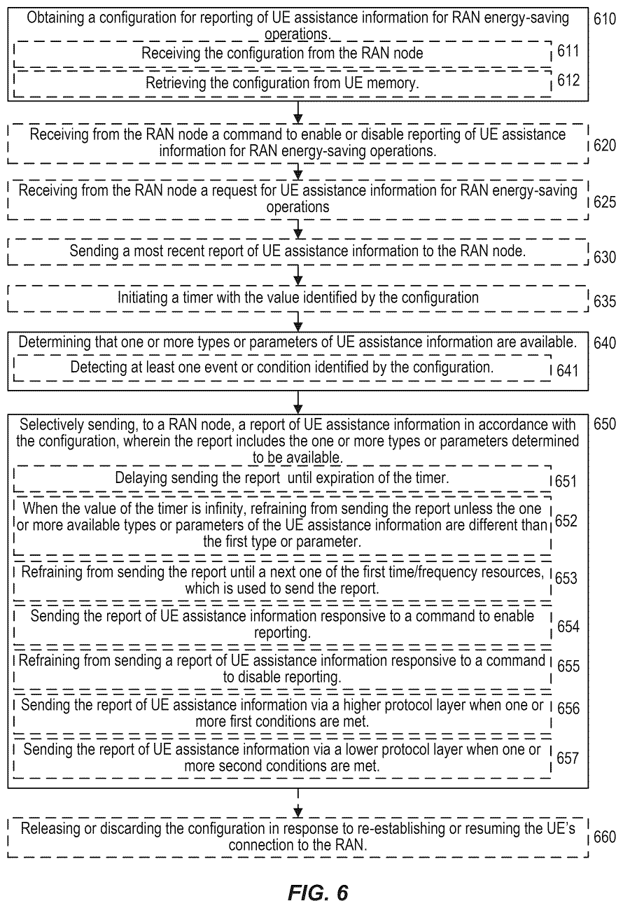

FIG. 8 shows an example of a communication system 800 in accordance with some embodiments. In this example, communication system 800 includes a telecommunication network 802 that includes an access network 804 (e.g., RAN) and a core network 806, which includes one or more core network nodes 808. Access network 804 includes one or more access network nodes, such as network nodes 810a-b (one or more of which may be generally referred to as network nodes 810), or any other similar 3GPP access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, telecommunication network 802 includes one or more Open-RAN (ORAN) network nodes. An ORAN network node is a node in telecommunication network 802 that supports an ORAN specification (e.g., a specification published by the O-RAN Alliance, or any similar organization) and may operate alone or together with other nodes to implement one or more functionalities of any node in telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. Network nodes 810 facilitate direct or indirect connection of UEs, such as by connecting UEs 812a-d (one or more of which may be generally referred to as UEs 812) to core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 800 may include any number of wired or wireless networks, network nodes, UEs, and/or any other components or systems that may facilitate or participate in the communication of data and/or signals whether via wired or wireless connections. Communication system 800 may include and/or interface with any type of communication, telecommunication, data, cellular, radio network, and/or other similar type of system.

UEs 812 may be any of a wide variety of communication devices, including wireless devices arranged, configured, and/or operable to communicate wirelessly with network nodes 810 and other communication devices. Similarly, network nodes 810 are arranged, capable, configured, and/or operable to communicate directly or indirectly with UEs 812 and/or with other network nodes or equipment in telecommunication network 802 to enable and/or provide network access, such as wireless network access, and/or to perform other functions, such as administration in telecommunication network 802.

In the depicted example, core network 806 connects network nodes 810 to one or more hosts, such as host 816. These connections may be direct or indirect via one or more intermediary networks or devices. In other examples, network nodes may be directly coupled to hosts. Core network 806 includes one or more core network nodes (e.g., 808) that are structured with hardware and software components. Features of these components may be substantially similar to those described with respect to the UEs, network nodes, and/or hosts, such that the descriptions thereof are generally applicable to the corresponding components of core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 816 may be under the ownership or control of a service provider other than an operator or provider of access network 804 and/or telecommunication network 802, and may be operated by the service provider or on behalf of the service provider. Host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 802 is a cellular network that implements 3GPP standardized features. Accordingly, telecommunication network 802 may support network slicing to provide different logical networks to different devices that are connected to telecommunication network 802. For example, telecommunication network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 812 are configured to transmit and/or receive information without direct human interaction. For instance, a UE may be designed to transmit information to access network 804 on a predetermined schedule, when triggered by an internal or external event, or in response to requests from access network 804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 814 communicates with access network 804 to facilitate indirect communication between one or more UEs (e.g., UE 812c and/or 812d) and network nodes (e.g., network node 810b). In some examples, hub 814 may be a controller, router, content source and analytics, or any of the other communication devices described herein regarding UEs. For example, hub 814 may be a broadband router enabling access to core network 806 for the UEs. As another example, hub 814 may be a controller that sends commands or instructions to one or more actuators in the UEs. Commands or instructions may be received from the UEs, network nodes 810, or by executable code, script, process, or other instructions in hub 814. As another example, hub 814 may be a data collector that acts as temporary storage for UE data and, in some embodiments, may perform analysis or other processing of the data. As another example, hub 814 may be a content source. For example, for a UE that is a VR headset, display, loudspeaker or other media delivery device, hub 814 may retrieve VR assets, video, audio, or other media or data related to sensory information via a network node, which hub 814 then provides to the UE either directly, after performing local processing, and/or after adding additional local content. In still another example, hub 814 acts as a proxy server or orchestrator for the UEs, such as when one or more of the UEs are low energy IoT devices.

Hub 814 may have a constant/persistent or intermittent connection to network node 810b. Hub 814 may also allow for a different communication scheme and/or schedule between hub 814 and UEs (e.g., 812c and/or 812d), and between hub 814 and core network 806. In other examples, hub 814 is connected to core network 806 and/or one or more UEs via a wired connection. Moreover, hub 814 may be configured to connect to an M2M service provider over access network 804 and/or to another UE over a direct connection. In some scenarios, UEs may establish a wireless connection with network nodes 810 while still connected via hub 814 via a wired or wireless connection. In some embodiments, hub 814 may be a dedicated hub-that is, a hub whose primary function is to route communications to/from the UEs from/to network node 810b. In other embodiments, hub 814 may be a non-dedicated hub-that is, a device which can operate to route communications between the UEs and network node 810b, but which is additionally capable of operating as a communication start and/or end point for certain data channels.

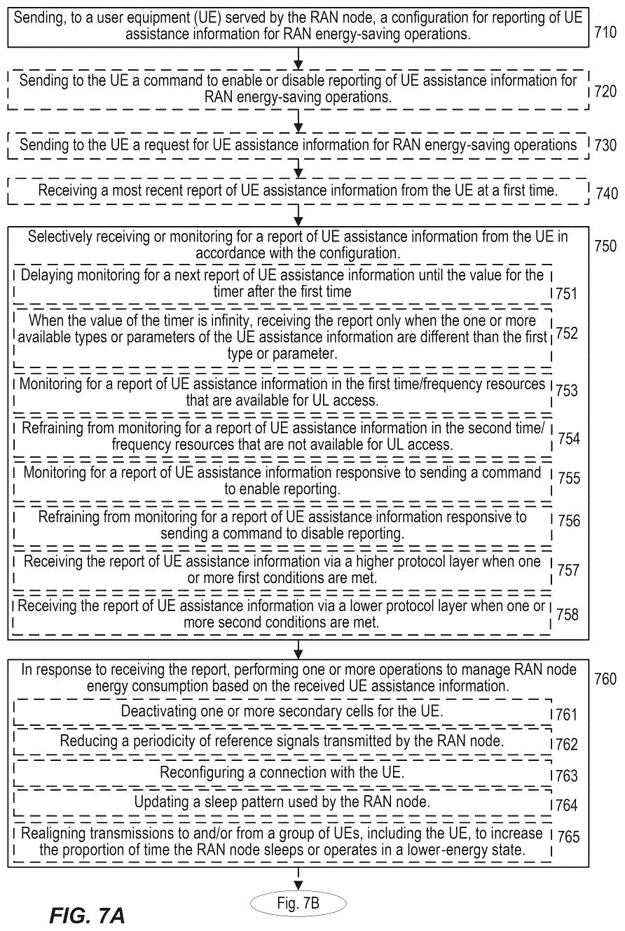

FIG. 9 shows a UE 900 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by 3GPP, including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

Processing circuitry 902 is configured to process instructions and data and may be configured to implement any sequential state machine operative to execute instructions stored as machine-readable computer programs in memory 910. Processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 902 may include multiple central processing units (CPUs).

In the example, input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 908 is structured as a battery or battery pack. Other types of power sources, such as an external power source (e.g., an electricity outlet), photovoltaic device, or power cell, may be used. Power source 908 may further include power circuitry for delivering power from power source 908 itself, and/or an external power source, to the various parts of UE 900 via input circuitry or an interface such as an electrical power cable. Delivering power may be, for example, for charging of power source 908. Power circuitry may perform any formatting, converting, or other modification to the power from power source 908 to make the power suitable for the respective components of UE 900 to which power is supplied.

Memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 910 includes one or more application programs 914, such as an operating system, web browser application, a widget, gadget engine, or other application, and corresponding data 916. Memory 910 may store, for use by UE 900, any of a variety of various operating systems or combinations of operating systems.

Memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 910 may allow UE 900 to access instructions, application programs and the like, stored on transitory or non-transitory memory media, to off-load data, or to upload data. An article of manufacture, such as one utilizing a communication system may be tangibly embodied as or in memory 910, which may be or comprise a device-readable storage medium.

Processing circuitry 902 may be configured to communicate with an access network or other network using communication interface 912. Communication interface 912 may comprise one or more communication subsystems and may include or be communicatively coupled to an antenna 922. Communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, transmitter 918 and receiver 920 may be coupled to one or more antennas (e.g., antenna 922) and may share circuit components, software, or firmware, or alternatively be implemented separately.

In the illustrated embodiment, communication functions of communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 900 shown in FIG. 9.

As another specific example, in an IoT scenario, a UE may represent a machine or other device that performs monitoring and/or measurements, and transmits the results of such monitoring and/or measurements to another UE and/or a network node. The UE may in this case be an M 2M device, which may in a 3GPP context be referred to as an MTC device. For example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

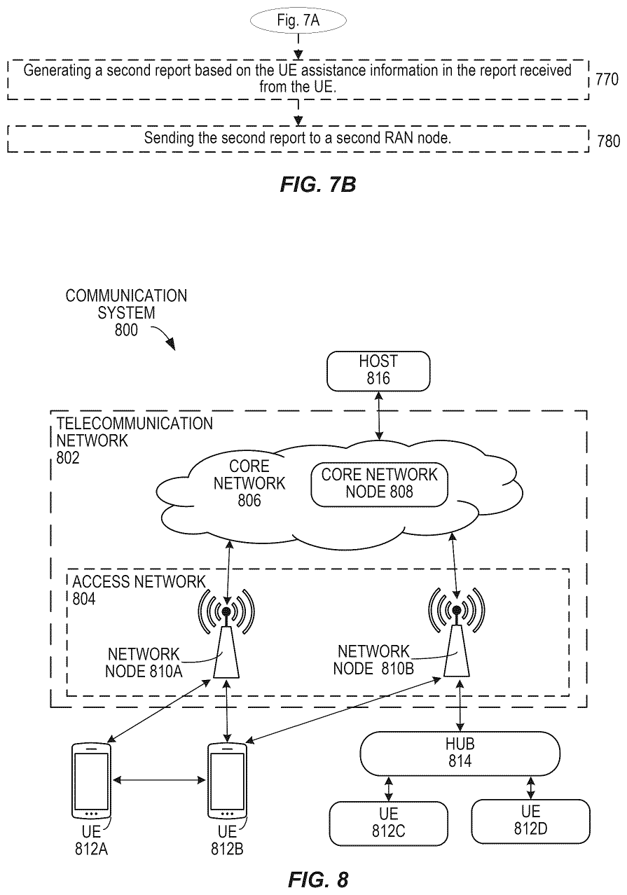

FIG. 10 shows a network node 1000 in accordance with some embodiments. Examples of network nodes include, but are not limited to, access points (APs) (e.g., radio access points), base stations (e.g., radio base stations, Node Bs, eNBs, gNBs), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1000 includes a processing circuitry 1002, a memory 1004, a communication interface 1006, and a power source 1008. Network node 1000 may be composed of multiple physically separate components (e.g., a NodeB component and a RNC component, or a BTS component and a BSC component, etc.), which may each have their own respective components. In certain scenarios in which network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). Network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, RF transceiver circuitry 1012 and baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

Memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. Memory 1004 may store any suitable instructions, data, or information, including a computer program, software, an application including one or more of logic, rules, code, tables, and/or other instructions (collected denoted computer program 1004a, which may be in the form of a computer program product) capable of being executed by the processing circuitry 1002 and utilized by network node 1000. Memory 1004 may be used to store any calculations made by the processing circuitry 1002 and/or any data received via communication interface 1006. In some embodiments, the processing circuitry 1002 and memory 1004 is integrated.

Communication interface 1006 is used in wired or wireless communication of signaling and/or data between a network node, access network, and/or UE. As illustrated, communication interface 1006 comprises port(s)/terminal(s) 1016 to send and receive data, for example to and from a network over a wired connection. Communication interface 1006 also includes radio front-end circuitry 1018 that may be coupled to, or in certain embodiments a part of, antenna 1010. Radio front-end circuitry 1018 comprises filters 1020 and amplifiers 1022. Radio front-end circuitry 1018 may be connected to an antenna 1010 and processing circuitry 1002. The radio front-end circuitry may be configured to condition signals communicated between antenna 1010 and processing circuitry 1002. Radio front-end circuitry 1018 may receive digital data that is to be sent out to other network nodes or UEs via a wireless connection. Radio front-end circuitry 1018 may convert the digital data into a radio signal having the appropriate channel and bandwidth parameters using a combination of filters 1020 and/or amplifiers 1022. The radio signal may then be transmitted via antenna 1010. Similarly, when receiving data, antenna 1010 may collect radio signals which are then converted into digital data by radio front-end circuitry 1018. The digital data may be passed to the processing circuitry 1002. In other embodiments, the communication interface may comprise different components and/or different combinations of components.

In certain alternative embodiments, network node 1000 does not include separate radio front-end circuitry 1018, instead, the processing circuitry 1002 includes radio front-end circuitry and is connected to antenna 1010. Similarly, in some embodiments, all or some of RF transceiver circuitry 1012 is part of communication interface 1006. In still other embodiments, communication interface 1006 includes one or more ports or terminals 1016, radio front-end circuitry 1018, and RF transceiver circuitry 1012, as part of a radio unit (not shown), and communication interface 1006 communicates with baseband processing circuitry 1014, which is part of a digital unit (not shown).

Antenna 1010 may include one or more antennas, or antenna arrays, configured to send and/or receive wireless signals. Antenna 1010 may be coupled to radio front-end circuitry 1018 and may be any type of antenna capable of transmitting and receiving data and/or signals wirelessly. In certain embodiments, antenna 1010 is separate from network node 1000 and connectable to network node 1000 through an interface or port.

Antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, antenna 1010, communication interface 1006, and/or the processing circuitry 1002 may be configured to perform any transmitting operations described herein as being performed by the network node. Any information, data and/or signals may be transmitted to a UE, another network node and/or any other network equipment.

Power source 1008 provides power to the various components of network node 1000 in a form suitable for the respective components (e.g., at a voltage and current level needed for each respective component). Power source 1008 may further comprise, or be coupled to, power management circuitry to supply the components of network node 1000 with power for performing the functionality described herein. For example, network node 1000 may be connectable to an external power source (e.g., the power grid, an electricity outlet) via an input circuitry or interface such as an electrical cable, whereby the external power source supplies power to power circuitry of power source 1008. As a further example, power source 1008 may comprise a source of power in the form of a battery or battery pack which is connected to, or integrated in, power circuitry. The battery may provide backup power should the external power source fail.

Embodiments of network node 1000 may include additional components beyond those shown in FIG. 10 for providing certain aspects of the network node's functionality, including any of the functionality described herein and/or any functionality necessary to support the subject matter described herein. For example, network node 1000 may include user interface equipment to allow input of information into network node 1000 and to allow output of information from network node 1000. This may allow a user to perform diagnostic, maintenance, repair, and other administrative functions for network node 1000.

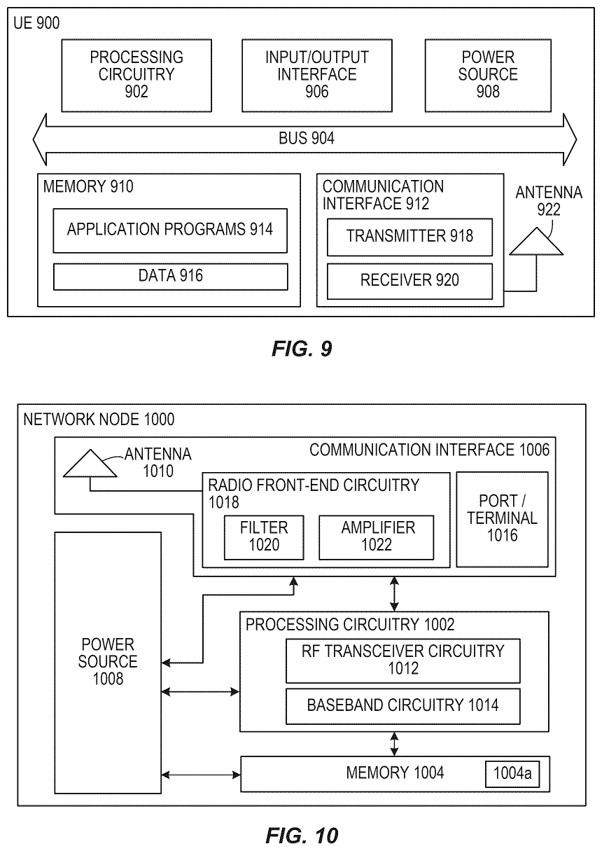

FIG. 11 is a block diagram of a host 1100, which may be an embodiment of host 816 of FIG. 8, in accordance with various aspects described herein. As used herein, host 1100 may be or comprise various combinations hardware and/or software, including a standalone server, a blade server, a cloud-implemented server, a distributed server, a virtual machine, container, or processing resources in a server farm. Host 1100 may provide one or more services to one or more UEs.

Host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

Memory 1112 may include one or more computer programs including one or more host application programs 1114 and data 1116, which may include user data, e.g., data generated by a UE for host 1100 or data generated by host 1100 for a UE. Embodiments of host 1100 may utilize all or only a subset of the components shown. Host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1114 may also provide for user authentication and licensing checks and may periodically report health, routes, and content availability to a central node, such as a device in or on the edge of a core network. Accordingly, host 1100 may select and/or indicate a different host for over-the-top services for a UE. Host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

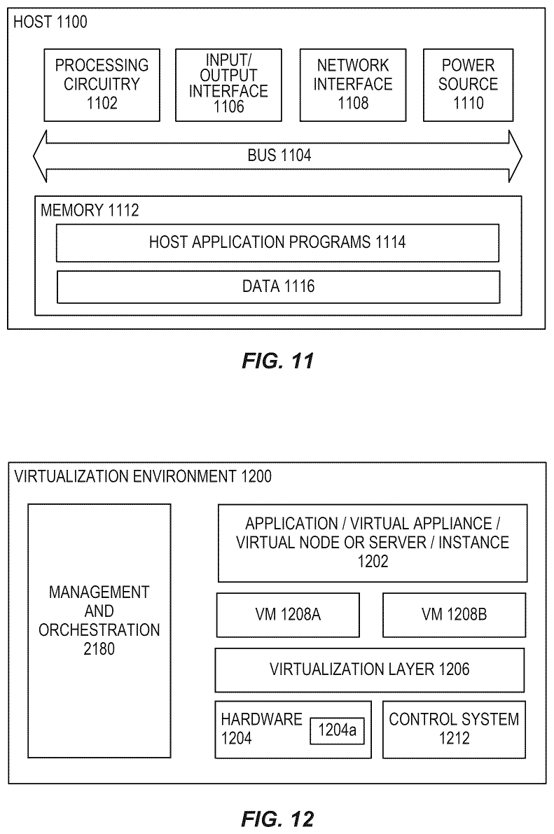

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1200 includes components defined by the O-RAN Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions (collected denoted computer program 1204a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. Virtualization layer 1206 may present a virtual operating platform that appears like networking hardware to the VMs 1208.

VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers.

In the context of NFV, each VM 1208 may be a software implementation of a physical machine that runs programs as if they were executing on a physical, non-virtualized machine. Each VM 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration function 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

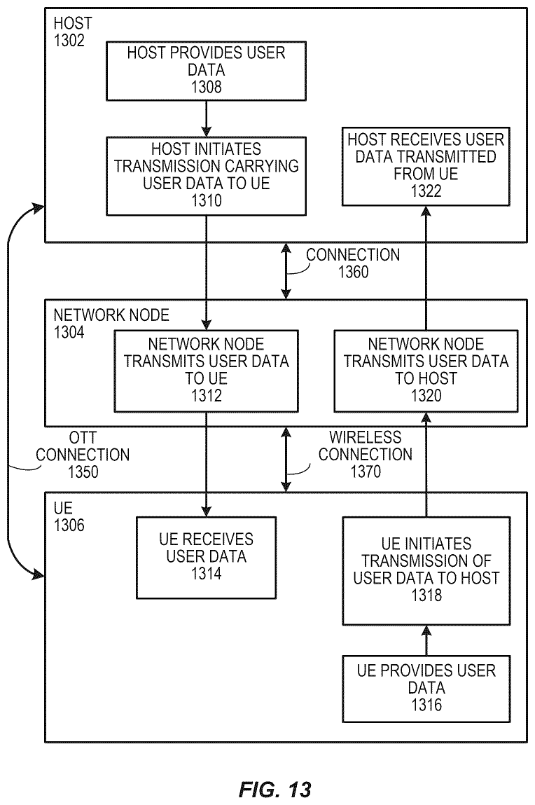

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. Host 1302 also includes software, which is stored in or accessible by host 1302 and executable by the processing circuitry. The software includes a host application that may be operable to provide a service to a remote user, such as UE 1306 connecting via an over-the-top (OTT) connection 1350 extending between UE 1306 and host 1302. In providing the service to the remote user, a host application may provide user data which is transmitted using OTT connection 1350.

Network node 1304 includes hardware enabling it to communicate with host 1302 and UE 1306. Connection 1360 may be direct or pass through a core network (like core network 806 of FIG. 8) and/or one or more other intermediate networks, such as one or more public, private, or hosted networks. For example, an intermediate network may be a backbone network or the Internet.

UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of host 1302. In host 1302, an executing host application may communicate with the executing client application via OTT connection 1350 terminating at UE 1306 and host 1302. In providing the service to the user, the UE's client application may receive request data from the host's host application and provide user data in response to the request data. OTT connection 1350 may transfer both the request data and the user data. The UE's client application may interact with the user to generate the user data that it provides to the host application through OTT connection 1350.

OTT connection 1350 may extend via a connection 1360 between host 1302 and network node 1304 and via a wireless connection 1370 between network node 1304 and UE 1306 to provide the connection between host 1302 and UE 1306. Connection 1360 and wireless connection 1370, over which OTT connection 1350 may be provided, have been drawn abstractly to illustrate the communication between host 1302 and UE 1306 via network node 1304, without explicit reference to any intermediary devices and the precise routing of messages via these devices.

As an example of transmitting data via OTT connection 1350, in step 1308, host 1302 provides user data, which may be performed by executing a host application. In some embodiments, the user data is associated with a particular human user interacting with UE 1306. In other embodiments, the user data is associated with a UE 1306 that shares data with host 1302 without explicit human interaction. In step 1310, host 1302 initiates a transmission carrying the user data towards UE 1306. Host 1302 may initiate the transmission responsive to a request transmitted by UE 1306. The request may be caused by human interaction with UE 1306 or by operation of the client application executing on UE 1306. The transmission may pass via network node 1304, in accordance with the teachings of the embodiments described throughout this disclosure. Accordingly, in step 1312, network node 1304 transmits to UE 1306 the user data that was carried in the transmission that host 1302 initiated, in accordance with the teachings of the embodiments described throughout this disclosure. In step 1314, UE 1306 receives the user data carried in the transmission, which may be performed by a client application executed on UE 1306 associated with the host application executed by host 1302.

In some examples, UE 1306 executes a client application which provides user data to host 1302. The user data may be provided in reaction or response to the data received from host 1302. Accordingly, in step 1316, UE 1306 may provide user data, which may be performed by executing the client application. In providing the user data, the client application may further consider user input received from the user via an input/output interface of UE 1306. Regardless of how the user data was provided, UE 1306 initiates, in step 1318, transmission of the user data towards host 1302 via network node 1304. In step 1320, in accordance with the teachings of the embodiments described throughout this disclosure, network node 1304 receives user data from UE 1306 and initiates transmission of the received user data towards host 1302. In step 1322, host 1302 receives the user data carried in the transmission initiated by UE 1306.

One or more of the various embodiments improve the performance of OTT services provided to UE 1306 using OTT connection 1650, in which wireless connection 1370 forms the last segment. More precisely, embodiments can enable a RAN node to trigger the reporting of UE assistance information from the UE in various ways that are appropriate to the type of UE assistance information being reported. As a specific example, the RAN node can cause the UE to report slowly changing UE assistance information in a different way than the UE reports UE assistance information that changes more quickly. As another specific example, the RAN node can set various events or conditions that cause the UE to report UE assistance information, thereby ensuring that the RAN node receives needed or desired UE assistance information in a timely manner. Based on timely receipt of appropriate UE assistance information, the RAN node can take various actions to manage and/or reduce its own energy consumption. At a high level, embodiments can improve energy consumption of a RAN based on UE assistance information, without placing significant burden on UEs to report such information. When RANs and UEs improved in this manner are used to deliver OTT services, they increase the value of these OTT services to end users and service providers.

In an example scenario, factory status information may be collected and analyzed by host 1302. As another example, host 1302 may process audio and video data which may have been retrieved from a UE for use in creating maps. As another example, host 1302 may collect and analyze real-time data to assist in controlling vehicle congestion (e.g., controlling traffic lights). As another example, host 1302 may store surveillance video uploaded by a UE. As another example, host 1302 may store or control access to media content such as video, audio, VR or AR which it can broadcast, multicast or unicast to UEs. As other examples, host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1350 between host 1302 and UE 1306, in response to variations in the measurement results. The measurement procedure and/or the network functionality for reconfiguring the OTT connection may be implemented in software and hardware of host 1302 and/or UE 1306. In some embodiments, sensors (not shown) may be deployed in or in association with other devices through which OTT connection 1350 passes; the sensors may participate in the measurement procedure by supplying values of the monitored quantities exemplified above, or supplying values of other physical quantities from which software may compute or estimate the monitored quantities. The reconfiguring of OTT connection 1350 may include message format, retransmission settings, preferred routing etc. ; the reconfiguring need not directly alter the operation of network node 1304. Such procedures and functionalities may be known and practiced in the art. In certain embodiments, measurements may involve proprietary UE signaling that facilitates measurements of throughput, propagation times, latency, and the like, by host 1302. The measurements may be implemented in that software causes messages to be transmitted (e.g., empty or ‘dummy’ messages) using OTT connection 1350 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings, and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously.

Example embodiments of the techniques and apparatus described herein include, but are not limited to, the following enumerated examples:

### Group A Embodiments

1. A method performed by a user equipment (UE) for triggering the reporting of assistance information, the method comprising:
   obtaining configuration information related to reporting assistance information;
   determining that a report comprising assistance information should be transmitted; and
   transmitting the report to a network node, the report comprising assistance information.
2. The method of 1 wherein the configuration information specifies one or more types of assistance information to be reported to the network node.
3. The method any of 1-2 wherein the configuration information specifies one or more triggering events for when the report should be transmitted.
4. The method of any of 1-3 wherein obtaining the configuration information comprises receiving a message comprising the configuration information.
5. The method of any of 1-3 wherein obtaining the configuration information comprises the UE being preconfigured with the configuration information.
6. The method of any of 1-3 wherein the configuration information is specified in a standard.
7. The method of any of 1-6 wherein determining that a report should be transmitted comprises receiving a command to allow or prohibit the transmitting of the report.
8. The method of 7 wherein the command comprises a MAC command
9. The method of any of 1-6 wherein determining that a report should be transmitted comprises determining that there is a need to assist the network with energy savings.
10. The method of any of 1-6 wherein determining that a report should be transmitted comprises determining that one or more thresholds have been met.
11. The method of any of 1-10 further comprising running a timer, wherein the report will not be transmitted until the timer finishes.
12. The method of any of 1 -11 wherein determining that a report should be sent comprises determining if one or more conditions have been met after sending a previous report.
13. The method of any of 1-12 wherein determining that a report should be sent comprises detecting the occurrence of a specific event.
14. The method of any of 1-13 wherein the report is transmitted based on an event/knowledge that is known only to the UE.
15. The method of any of 1-13 wherein the report is transmitted based on an event/knowledge that is known only to the network.
16. The method of any of 1-15 wherein determining that a report should be sent comprises determining that a procedure has completed.
17. The method of 16 wherein the procedure comprises one of a handover procedure, a reconfiguration procedure, a connection setup procedure, a re-establishment procedure, or a resume procedure.
18. The method of any of 1-15 wherein the determining that a report should be sent comprises determining that the UE is about to be suspended.
19. The method of any of 1-18 wherein the configuration information is different for a Master Cell Group (MCG) and a secondary cell group (SCG).
20. The method of any of 1-19 wherein the report is transmitted frequently.
21. The method of 20 wherein the report is transmitted via lower layers such as MAC layer.
22. The method of any of 1-19 wherein the report is transmitted seldomly.
23. The method of 22 wherein the report is transmitted upon the UE establishing a connection with the network node.
24. The method of any of 1-23 wherein transmitting the report comprises transmitting the report via RRC.
25. The method of any of 1-24 wherein the report is transmitted on a periodic basis.
26. The method of any of 1-24 wherein the report is transmitted on an aperiodic basis.
27. The method of any of 1-26 further comprising choosing among predefined ranges/values for relevant parameters.
28. The method of 27 wherein the report comprises an index value associated with the predefined range/value.
29. The method of any of the previous embodiments, further comprising:
   providing user data; and
   forwarding the user data to a host via the transmission to the network node.

### Group B Embodiments

30. A method performed by a network node for triggering the reporting of assistance information, the method comprising:
   receiving a report from a user equipment, the report comprising assistance information.
31. The method of 30 further comprising transmitting configuration information to the UE, the configuration information specifying one or more parameters of the report.
32. The method of 30 wherein the report is received via RRC, MAC or L1 mechanisms.
33. The method of any of 31-32 wherein the configuration information comprises one or more triggers for sending the report.
34. The method of any of 31-33 wherein the configuration information comprises specific format requirement that the UE is to use for the report.
35. The method of any of 31-34 wherein the configuration information comprises restrictions on the timing of when the UE can transmit the report.
36. The method of any of 31-35 further comprising:
   upon receiving the report, generating a second report; and
   sending the second report to a second network node.
37. The method of any of 31-36 further comprising activating or deactivating one or more secondary cells based on the report.
38. The method of any of 31-37 further comprising reconfigure one or more connections associated with the UE.
39. The method of any of 31-37 further comprising reconfigure one or more connections associated with a plurality of UEs.
40. The method of any of 31-39 further comprising updating one or more energy-saving techniques.
41. The method of 40 wherein updating one or more energy saving techniques comprises updating a sleeping pattern.
42. The method of any of the previous embodiments, further comprising:
   obtaining user data; and
   forwarding the user data to a host or a user equipment.

### Group C Embodiments

43. A user equipment for triggering the reporting of assistance information, comprising:
   processing circuitry configured to perform any of the steps of any of the Group A embodiments; and
   power supply circuitry configured to supply power to the processing circuitry.
44. A network node for triggering the reporting of assistance information, the network node comprising:
   processing circuitry configured to perform any of the steps of any of the Group B embodiments; and
   power supply circuitry configured to supply power to the processing circuitry.
45. A user equipment (UE) for triggering the reporting or assistance information, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
46. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
47. The host of the previous embodiment, wherein the cellular network further includes a network node configured to communicate with the UE to transmit the user data to the UE from the host.
48. The host of the previous 2 embodiments, wherein:
   the processing circuitry of the host is configured to execute a host application, thereby providing the user data; and
   the host application is configured to interact with a client application executing on the UE, the client application being associated with the host application.
49. A method implemented by a host operating in a communication system that further includes a network node and a user equipment (UE), the method comprising:
   providing user data for the UE; and
   initiating a transmission carrying the user data to the UE via a cellular network comprising the network node,
   wherein the UE performs any of the operations of any of the Group A embodiments to receive the user data from the host.
50. The method of the previous embodiment, further comprising, at the host, executing a host application associated with a client application executing on the UE to receive the user data from the UE.
51. The method of the previous embodiment, further comprising:
   at the host, transmitting input data to the client application executing on the UE, the input data being provided by executing the host application,
   wherein the user data is provided by the client application in response to the input data from the host application.
52. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
53. The host of the previous embodiment, wherein the cellular network further includes a network node configured to communicate with the UE to transmit the user data from the UE to the host.
54. The host of the previous 2 embodiments, wherein:
   the processing circuitry of the host is configured to execute a host application, thereby providing the user data; and
   the host application is configured to interact with a client application executing on the UE, the client application being associated with the host application.
55. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
56. The method of the previous embodiment, further comprising, at the host, executing a host application associated with a client application executing on the UE to receive the user data from the UE.
57. The method of the previous embodiment, further comprising:
   at the host, transmitting input data to the client application executing on the UE, the input data being provided by executing the host application,
   wherein the user data is provided by the client application in response to the input data from the host application.
58. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
59. The host of the previous embodiment, wherein:
   the processing circuitry of the host is configured to execute a host application that provides the user data; and
   the UE comprises processing circuitry configured to execute a client application associated with the host application to receive the transmission of user data from the host.
60. A method implemented in a host configured to operate in a communication system that further includes a network node and a user equipment (UE), the method comprising:
   providing user data for the UE; and
   initiating a transmission carrying the user data to the UE via a cellular network comprising the network node,
   wherein the network node performs any of the operations of any of the Group B embodiments to transmit the user data from the host to the UE.
61. The method of the previous embodiment, further comprising, at the network node, transmitting the user data provided by the host for the UE.
62. The method of any of the previous 2 embodiments, wherein the user data is provided at the host by executing a host application that interacts with a client application executing on the UE, the client application being associated with the host application.
63. A communication system configured to provide an over-the-top service, the communication system comprising:
   a host comprising:
      processing circuitry configured to provide user data for a user equipment (UE), the user data being associated with the over-the-top service; and
      a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
64. The communication system of the previous embodiment, further comprising the network node and/or the user equipment.
65. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
66. The host of the previous 2 embodiments, wherein:
   the processing circuitry of the host is configured to execute a host application, thereby providing the user data; and
   the host application is configured to interact with a client application executing on the UE, the client application being associated with the host application.
67. The host of the any of the previous 2 embodiments, wherein the initiating receipt of the user data comprises requesting the user data.
68. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
69. The method of the previous embodiment, further comprising at the network node, transmitting the received user data to the host.

1. A method performed by a user equipment, UE, for facilitating radio access network, RAN, energy-saving operations, the method comprising:
obtaining a configuration for reporting of UE assistance information for RAN energy-saving operations;
determining that one or more types or parameters of UE assistance information are available; and
selectively sending, to a RAN node, a report of UE assistance information in accordance with the configuration, wherein the report includes the one or more types or parameters determined to be available.

2. The method of claim 1, wherein:
the configuration for reporting of UE assistance information identifies at least one type or parameter of UE assistance information to be reported by the UE, and
the one or more types or parameters determined to be available are among the at least one type or parameter to be reported.

3. The method of claim 1 wherein:
the configuration for reporting of UE assistance information identifies one or more conditions or events that trigger reporting of UE assistance information, and
determining that one or more types or parameters of UE assistance information are available comprises detecting at least one event or condition identified by the configuration.

4. (canceled)

5. The method of claim 1, wherein:
the method further comprises upon sending a most recent report of UE assistance information to the RAN node, initiating a timer with the value identified by the configuration;
the timer is running when it is determined that the one or more types or parameters of UE assistance information are available; and
selectively sending the report of UE assistance information comprises delaying sending the report until expiration of the timer.

6. The method of claim 5, wherein:
the most recent report includes a first type or parameter of UE assistance information; and
selectively sending the report of UE assistance information further comprises, when the value of the timer is infinity, refraining from sending the report unless the one or more available types or parameters of the UE assistance information are different than the first type or parameter.

8. (canceled)

9. The method of claim 1, wherein:
the UE is configured to operate in dual connectivity, DC, with a master cell group, MCG, and a secondary cell group, SCG; and
the configuration for reporting of UE assistance information includes a first set of conditions or events that trigger reporting of UE assistance information associated with the MCG and a second set of conditions or events that trigger reporting of UE assistance information associated with the SCG.

10. The method claim 1, wherein:
the configuration for reporting of UE assistance information includes an indication of a RAN node sleep pattern, which includes one or more first time/frequency resources that are available for uplink, UL, access by UEs and one or more second time/frequency resources that are unavailable for UL access by UEs due to the RAN node being in a lower-energy state; and
selectively sending the report of UE assistance information comprises refraining from sending the report until a next one of the first time/frequency resources, which is used to send the report.

11. (canceled)

12. The method of claim 1, wherein:
the method further comprises receiving from the RAN node a command to enable or disable reporting of UE assistance information for RAN energy-saving operations;
selectively sending the report of UE assistance information comprises:
sending the report of UE assistance information responsive to a command to enable reporting; and
refraining from sending the report of UE assistance information responsive to a command to disable reporting.

13. The method of any of, wherein selectively sending the report of UE assistance information comprises:
sending the report of UE assistance information via a higher protocol layer when one or more first conditions are met; and
sending the report of UE assistance information via a lower protocol layer when one or more second conditions are met.

14.-18. (canceled)

19. A method performed by a radio access network, RAN, node for managing RAN node energy consumption, the method comprising:
sending, to a user equipment, UE, served by the RAN node, a configuration for reporting of UE assistance information for RAN energy-saving operations;
selectively receiving or monitoring for a report of UE assistance information from the UE in accordance with the configuration; and
in response to receiving the report, performing one or more operations to manage RAN node energy consumption based on the received UE assistance information.

20. The method of claim 19, wherein:
the configuration for reporting of UE assistance information identifies at least one type or parameter of UE assistance information to be reported by the UE, and
the report includes one or more of the at least one type or parameter to be reported.

21. The method of claim 19, wherein the configuration for reporting of UE assistance information identifies one or more conditions or events that trigger reporting of UE assistance information.

22. (canceled)

23. The method of claim 19 wherein:
the method further comprises receiving a most recent report of UE assistance information from the UE at a first time; and
selectively receiving or monitoring for a report of UE assistance information comprises delaying monitoring for a next report of UE assistance information until the value for the timer after the first time.

24. The method of claim 23, wherein:
the most recent report includes a first type or parameter of UE assistance information; and
selectively receiving or monitoring for a report of UE assistance information further comprises, when the value of the timer is infinity, receiving the report only when the one or more available types or parameters of the UE assistance information are different than the first type or parameter.

25.-26. (canceled)

27. The method of claim 19, wherein:
the UE is configured to operate in dual connectivity, DC, with a master cell group, MCG, and a secondary cell group, SCG; and
the configuration for reporting of UE assistance information includes a first set of conditions or events that trigger reporting of UE assistance information associated with the MCG and a second set of conditions or events that trigger reporting of UE assistance information associated with the SCG.

28. The method of claim 19, wherein:
the configuration for reporting of UE assistance information includes an indication of a RAN node sleep pattern, which includes one or more first time/frequency resources that are available for uplink, UL, access by UEs and one or more second time/frequency resources that are unavailable for UL access by UEs due to the RAN node being in a lower-energy state; and
selectively receiving or monitoring for a report of UE assistance information comprises:
monitoring for a report of UE assistance information in the first time/frequency resources that are available for UL access, and
refraining from monitoring for a report of UE assistance information in the second time/frequency resources that are not available for UL access.

29. (canceled)

30. The method of claim 19, wherein:
the method further comprises sending to the UE a command to enable or disable reporting of UE assistance information for RAN energy-saving operations; and
selectively receiving or monitoring for a report of UE assistance information comprises:
monitoring for a report of UE assistance information responsive to sending a command to enable reporting; and
refraining from monitoring for a report of UE assistance information responsive to sending a command to disable reporting.

31. The method of claim 19, wherein selectively receiving or monitoring for a report of UE assistance information comprises:
receiving the report of UE assistance information via a higher protocol layer when one or more first conditions are met; and
receiving the report of UE assistance information via a lower protocol layer when one or more second conditions are met.

32.-34. (canceled)

35. The method of claim 19, further comprising:
generating a second report based on the UE assistance information in the report received from the UE; and
sending the second report to a second RAN node.

36. The method of claim 35, wherein the second report is sent to the second RAN node during handover of the UE to a cell served by the second RAN node.

37. The method of any of claims 19, wherein performing one or more operations to manage RAN node energy consumption based on the received UE assistance information includes one or more of the following:
deactivating one or more secondary cells for the UE;
reducing a periodicity of reference signals transmitted by the RAN node;
reconfiguring a connection with the UE;
updating a sleep pattern used by the RAN node; and
realigning transmissions to and/or from a group of UEs, including the UE, to increase the proportion of time the RAN node sleeps or operates in a lower-energy state.

38. A user equipment, UE configured to facilitate radio access network, RAN energy-saving operations, the UE comprising:
communication interface circuitry configured to communicate with the RAN; and
processing circuitry operatively coupled to the communication interface circuitry, whereby the processing circuitry and the communication interface circuitry are configured to:
obtain a configuration for reporting of UE assistance information for RAN energy-saving operations;
determine that one or more types or parameters of UE assistance information are available; and
selectively send, to a RAN node, a report of UE assistance information in accordance with the configuration, wherein the report includes the one or more types or parameters determined to be available.

39.-43. (canceled)

44. A radio access network, RAN, node, configured to manage RAN node energy consumption, the RAN node comprising:
communication interface circuitry configured to communicate with one or more user equipment, UEs and
processing circuitry operatively coupled to the communication interface circuitry, whereby the processing circuitry and the communication interface circuitry are configured to:
send, to a UE served by the RAN node, a configuration for reporting of UE assistance information for RAN energy-saving operations;
selectively receive or monitor for a report of UE assistance information from the UE in accordance with the configuration; and
in response to receiving the report, perform one or more operations to manage RAN node energy consumption based on the received UE assistance information.

45.-49. (canceled)
